(19) United States
(12) Patent Application Publication
(10) Pub. No.: US 2014/0279949 A1
(43) Pub. Date: Sep. 18, 2014

(54) Method and system for Data De-Duplication in storage devices

(71) Applicant: Kadari Subbarao Sudeendra Thirtha Koushik, Bangalore (IN)

(72) Inventor: Kadari Subbarao Sudeendra Thirtha Koushik, Bangalore (IN)

(21) Appl. No.: 13/801,185

(22) Filed: Mar. 13, 2013

(51) Int. Cl. G06F 17/30

(52) U.S. Cl. CPC G06F 17/30156
USPC 707/692

(57) ABSTRACT

A method and system for data de-duplication in storage devices is disclosed. The method scans for the content within the storage device. When the method obtains all the content within the storage device, it checks for the duplicate content in the storage device. The method identifies duplicate content based on two criteria which include parametric level and Meta data level. The method switches to Meta data level when the method fails to identify duplicate content in parametric level. Further, the method obtains the input from user to delete or retain the duplicate content. If the user provides a confirmation for deleting the duplicate content, the method deletes the duplicate content.

The present application is based on, and claims priority from, IN Application Number 4672/CHE/2012, filed on 7 Nov. 2012, the disclosure of which is hereby incorporated by reference herein.

### TECHNICAL FIELD

The embodiments herein relate to data processing systems and more particularly to data de-duplication in storage device(s).

### BACKGROUND

Data processing systems, computers, networks of computers, or the like, typically offer users various ways to identify the data in the system. Users typically identify data in the data processing system by giving the data with some form of identification. For example, a typical operating system (OS) on a computer provides a file system in which data items are named by alphanumeric identifiers. Programs typically identify data in the data processing system using a location or an address. For example, a program may identify a record in a file or database by using a record number which serves to locate that record.

In many data processing systems or environments, data items are transferred between different locations in the system. These locations may be storage devices, memory, or the like. For example, one location may obtain a data item from another location or from an external storage device and may incorporate that data item into its system (using the name provided with that data item). However, when a certain location obtains a data item from another location in the data processing system, it is possible that this obtained data item is already present in the system or storage device and therefore a duplicate of the data item is created. This situation is common in a network data processing environment where proprietary software products are installed from storage devices onto several locations sharing a common file server. In these systems, it is often the case that the same file will be installed on several systems, so that several copies of each file will reside on the common file server.

Generally heavy form factor content like high resolution pictures, video files, music files and even large documents are stored in multiple locations, thus wasting precious storage space in the storage device. Due to multiple copies of the same data, a lot of precious and expensive storage is being lost. This is a major loss in an embedded device such as TV, Tablet, Digital camera or Mobile phone where the storage comes at a premium. Further, users may be unaware of multiple contents in duplicate form in the same device and hence run out of space for new content. This can cause a substantial loss in a digital camera or capturing an image in a tablet or a phone.

In current market situations, where the storage capacity is increasing slower than the content creation rate. There is a need to utilize the available storage space in an effective manner such that the users can manage their content very carefully to make the best use of their available storage spaces.

In light of above discussion, it is desirable to have a mechanism for reducing multiple copies of content in a storage device and to have a mechanism which enables the identification of identical content so as to reduce multiple copies. It is further desirable to determine whether two instances of content are in fact the same content, and to perform various other system functions and applications on content.

### BRIEF DESCRIPTION OF THE FIGURES

The embodiments herein will be better understood from the following detailed description with reference to the drawings, in which:

FIG. 1 illustrates a block diagram of overall system, according to the embodiments disclosed herein;

FIG. 2 illustrates a flow diagram explaining the various steps involved in removing the duplicate content from storage device(s), according to the embodiments disclosed herein; and

FIG. 3 illustrates the computing environment implementing the data de-duplication method, according to the embodiments disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a method and system for data de-duplication in storage devices. The method described herein identifies the duplicate content within the storage device and deletes the duplicate content, upon receiving acceptance from the user of the storage device. In general, data de-duplication is a specialized technique for eliminating duplicate copies of repeating data.

In an embodiment, the storage devices can be any of a personal computer (PC), cell phone, tablet, media player, digital camera, flash drive or any electronic gadget comprising a non-volatile storage space.

Throughout the description, the terms duplicate content and multiple copies of same content are used interchangeably.

Referring now to the drawings, and more particularly to FIGS. 1 through 3, where similar reference characters denote corresponding features consistently throughout the figures, there are shown embodiments.

FIG. 1 illustrates a block diagram of overall system, according to the embodiments disclosed herein. As depicted in figure, the device 101 is installed with an application that helps in reducing multiple copies of content that are stored within the device 101. The application residing on the device scans for the duplicate content and reports the identified duplicate content to the user 100. The duplicate content in a device 101 refers to multiple copies of the same content that is stored in the device. Upon receiving acceptance from the user 100, the application within the device deletes the duplicate content from the device 101. Further, the method and system of data de-duplication described herein is either applicable to a single device 101 or it can be applicable when the device 101 is connected to other devices such as device 102 and device 103 through a wireless connection. For the purpose of demonstration, the device 101 connected to the devices 102 and 103 is shown within the dotted lines in the figure. The method and system of data-duplication disclosed herein identifies and deletes the duplicate content within the storage device.

The method of identification of duplicate content within a device 100 is done based on two criteria as described herein. The first criteria include the identification of duplicate content at parametric level. The parametric level for identification of duplicate content comprises searching of duplicate content within the storage device with certain parameters.

In an embodiment, parameters can be file stored date, file size, file creation date, file type, file location, file accessed date and the like.

Further, the identification of the duplicate content within the storage device using second criteria, which adopts a Meta data level for identifying the duplicate content. In an embodiment, the Meta data level parameters can be resolution, histogram, device information, codec and so on.

The application residing on the device 101 applies the parametric level criteria for identification of duplicate content within the device 101. If the parametric level criteria have identified the duplicate content within the device 101, then it reports the identified duplicate content to the user of the device. If the parametric level fails to identify the duplicate content, then the application uses the meta data level for identifying the duplicate content within the device 101.

Once the duplicate content is identified within the device 101 using meta data level, the application within the device displays the identified duplicate content with all the parameters as described above to the user of the device. In an embodiment, a prompt window is displayed to the user, where all the duplicate content with parameters such as file creation date, file stored date, file type and so on are indicated to the user. The user 100 can now choose the content that has to be deleted from the device 100. Further, the method of data de-duplication described herein may provide check boxes with corresponding duplicate content to the user 100, where he/she can select the duplicate content of his/her choice that needs to be deleted from the device 100. In an embodiment, if the user wants to have the duplicate content within the device 100, then the application provides a provision for retaining the duplicate content.

Upon obtaining the confirmation from the user 100, the duplicate content is deleted from the device 100. The method and system of data de-duplication described herein scans the device 100 at regular intervals of time to identify the duplicate content within the device 100. In an embodiment, the user 100 can schedule the application to run at certain intervals of time in day. Further, the application within the device 100 can be triggered using a script. For example, in a data center the application can be triggered using a script which runs at certain intervals in a day or a week as configured accordingly to the requirements and the duplicate content may be presented to the administrator of the data center.

In case of an embedded device such as mobile phone or laptop or any other personal digital assistant (PDA), there is provision for the user 100 to schedule the application to run within the device 100 at regular intervals of time.

Further, the method described herein can be able to delete the duplicate content form the device 101, which is connected to devices 102 and 103 wirelessly. In this the device 101, device 102 and device 103 are three different devices of the same user 100. Further, method of data de-duplication is also applicable when the device 101 is connected to other devices such as device 102 and 103 where all these devices are connected to the internet using wireless fidelity (Wi-Fi). The method is also applicable when the devices 101, 102 and 103 are connected to the internet using Wi-Fi direct) and are visible to other devices wirelessly. Further, the method of de-duplication is also applicable when the devices 101, 102 and 103 are connected to each other wirelessly without any internet connectivity.

The method and system of data de-duplication described herein provides an efficient way of utilizing limited and expensive memory of the device 100. Initially the application installed on the device 100 discovers the duplicate data. After discovering the duplicates the application allows the user 100 to view the reported duplicate content in various views. Further, the application decides to remove or retain the discovered the duplicates based on the input provided by the user 100.

FIG. 2 illustrates a flow diagram explaining the various steps involved in removing the duplicate content from storage device(s), according to the embodiments disclosed herein. Initially, the method scans (201) the device 100 for finding the content within the storage device. In an embodiment, the user 100 can configure the method to scan only targeted memory areas within the storage device. Once the scanning of the device 100 is done, the method obtains (202) all the content within the device 101. Further, the method applies (203) parametric level criteria for identifying the duplicate content within the device 101. The parametric level for identification of duplicate content comprises searching of duplicate content within the storage device with certain parameters.

The method determines (204) whether the applied parametric level has identified the duplicate content within the device 101. If the method determines that the parametric level criteria has identified the duplicate content, then the method displays (206) the duplicate content to the user in various views.

In an embodiment, the various views of allowing the duplicate content for viewing by the user 100 includes prioritizing the content that has been assigned with more space in the memory of the device 100. For example, a music file may occupy a lesser space when compared to an image file or a picture file. In such cases, initially, the number of duplicates related to the picture file is displayed to the user 100 and then the number of duplicates related to the music file is displayed to the user 100.

Further, if the method determines that the parametric level criteria have not identified any duplicate content within the device 101, the method applies (205) Meta data level criteria for identifying the duplicate content. After applying Meta data level criteria, the method displays (206) the duplicate content to the user in various views.

In an embodiment, the method displays the duplicate content and the parameters associated with the duplicate content are displayed to the user 100.

In an embodiment, a prompt window is displayed to the user 100, where all the duplicate content with parameters such as file creation date, file stored date, file type and so on are indicated to the user. The user 100 can then choose the content that has to be deleted from the device 100.

Finally, the method obtains the input from the user 100 to delete or retain the duplicate content within the device 100. In an embodiment, the method may provide check boxes with corresponding duplicate content to the user 100, where he/she can select the duplicate content of his/her choice that needs to be deleted from the device 100.

In an embodiment, if the user wants to retain the duplicate content within the device 100, then the method provides a provision for retaining the duplicate content with an appropriate indication in the form of a prompt window, which may display for example “retain the content” using a button. This prompt window seeks a confirmation from the user 100 for retaining the duplicate content within the device 100.

The method and system of data de-duplication provides a better utilization of various devices to store the data in one location. Further, the method of data de-duplication can be configured to perform automatically at storage or manually anytime. Using this method, the cost per every mega byte (MB) is optimized.

The method disclosed herein provides an intelligent method that detects duplicate data beyond just the file name. Further, the method provides an efficient user experience by providing graphical user interfaces (GUIs) while removing multiple copies of same content stored in a device.

FIG. 3 illustrates the computing environment implementing the method of data de-duplication, according to the embodiments disclosed herein. As depicted the computing environment 301 comprises at least one processing unit 304 that is equipped with a control unit 302 and an Arithmetic Logic Unit (ALU) 303, a memory 305, a storage unit 306, plurality of networking devices 308 and a plurality Input output (I/O) devices 307. The processing unit 304 is responsible for processing the instructions of the algorithm. The processing unit 304 receives commands from the control unit in order to perform its processing. Further, any logical and arithmetic operations involved in the execution of the instructions are computed with the help of the ALU 303.

The overall computing environment 301 can be composed of multiple homogeneous and/or heterogeneous cores, multiple CPUs of different kinds, special media and other accelerators. The processing unit 304 is responsible for processing the instructions of the algorithm. Further, the plurality of processing units 704 may be located on a single chip or over multiple chips.

The algorithm comprising of instructions and codes required for the implementation are stored in either the memory unit 305 or the storage 306 or both. At the time of execution, the instructions may be fetched from the corresponding memory 305 and/or storage 306, and executed by the processing unit 304.

In case of any hardware implementations various networking devices 308 or external I/O devices 307 may be connected to the computing environment to support the implementation through the networking unit and the I/O device unit.

The embodiments disclosed herein can be implemented through at least one software program running on at least one hardware device and performing network management functions to control the network elements. The network elements shown in FIGS. 1 and 3 include blocks which can be at least one of a hardware device, or a combination of hardware device and software module.

The embodiment disclosed herein specifies a method and system for data de-duplication in storage devices. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for removing multiple copies of same content, wherein said method comprises:
identifying said copies of same content based on parameters;
displaying said identified copies of same content to a user; and
obtaining input from said user for removing said identified copies of same content.

2. The method as in claim 1, wherein said same content is stored in at least one device.

3. The method as in claim 1, wherein said method identifies said copies of same content using at least one of parametric level, Meta data level.

4. The method as in claim 3, wherein said parametric level comprises at least one of: file stored date, file size, file creation date, file type, file location and file accessed date, wherein said Meta data level parameters comprises at least one of: resolution, histogram, said device information and codec.

5. The method as in claim 1, wherein said method identifies said copies of same content in said device by comparing said content with said copies of same content.

6. The method as in claim 3, wherein said method switches to said Meta data level, if said method fails to identify said copies of same content using said parametric level.

7. The method as in claim 1, wherein said method obtains input from said user, wherein said input comprises at least one of: delete, retain said identified copies of same content.

8. A system for removing multiple copies of same content, wherein said system comprises at least one device, an application stored in said device, further said system is configured to:
identify said copies of same content based on parameters;
display said identified copies of same content to a user; and
obtain input from said user to remove said identified copies of same content.

9. A computer program product for removing multiple copies of same content, wherein said product comprises:
an integrated circuit further comprising at least one processor;
at least one memory having a computer program code within said circuit;
said at least one memory and said computer program code configured to, with said at least one processor cause said product to:
identify said copies of same content based on parameters;
display said identified copies of same content to a user; and
obtain input from said user to remove said identified copies of same content.

10. The computer program product as in claim 9, wherein said same content is stored in at least one device.

11. The computer program product as in claim 9, wherein said product is configured to identify said copies of same content using at least one of parametric level, Meta data level.

12. The computer program product as in claim 11, wherein said parametric level comprises at least one of: file stored date, file size, file creation date, file type, file location and file accessed date, wherein said Meta data level parameters comprises at least one of: resolution, histogram, said device information and codec.

13. The computer program product as in claim 9, wherein said product is configured to identify said copies of same content in said device in parametric level by comparing said content with said copies of same content.

14. The computer program product as in claim 9, wherein said product is configured to switch to said Meta data level, if said product fails to identify said copies of same content using said parametric level.

15. The computer program product as in claim 9, wherein said product is configured to obtain input from said user, wherein said input comprises at least one of: delete or retain said identified copies of same content.
